(19) United States
(12) Patent Application Publication
(10) Pub. No.: US 2020/0127837 A1
(43) Pub. Date: Apr. 23, 2020

(54) PROTECTION OF USER AUTHORIZATION CODE USING ONE-TIME PASSWORDS

(71) Applicant: CA, Inc., New York, NY (US)

(72) Inventors: Mohammed Mujeeb Kaladgi, Bangalore (IN); Ruqiya Nikhat Kaladgi, Bangalore (IN); Shankar Krishnamoorthy, Bangalore (IN)

(21) Appl. No.: 16/165,409

(22) Filed: Oct. 19, 2018

(51) Int. Cl. H04L 9/32; H04L 29/06

(52) U.S. Cl. CPC H04L 9/3228; H04L 63/0838; G06Q 20/409; H04L 9/3242; H04L 63/10

(57) ABSTRACT

A method includes receiving, from a data processing system, a request for an authorization code, the authorization code comprising a sequence of a plurality of characters, generating a plurality of one-time passwords, wherein respective ones of the plurality of one-time passwords correspond to respective ones of the plurality of characters, generating a plurality of modified passwords, wherein generating the plurality of modified passwords comprises concatenating, for each of the plurality of one-time passwords and each of the plurality of characters, the one of the plurality of characters to the corresponding one of the plurality of one-time passwords, generating a plurality of hash values, wherein generating the plurality of hash values comprises performing a hash function on each of the plurality of modified passwords, and sending the plurality of hash values to the data processing system.

### BACKGROUND

The present disclosure relates to computing systems, and, in particular, to computing systems supporting secure transactions.

Various types of data processing systems support user transactions where the user is required to submit some type of authorization code. For example, an Interactive Voice Response (IVR) system may request a user to provide a payment card for a transaction along with a Personal Identification Number (PIN) code, which may serve as an authorization code for the transaction. The PIN code, however, may be transmitted over the communication network without any protection from eavesdropping by one or more hostile parties.

### SUMMARY

In some embodiments of the inventive subject matter, a method comprises receiving, from a data processing system, a request for an authorization code, the authorization code comprising a sequence of a plurality of characters, generating a plurality of one-time passwords, wherein respective ones of the plurality of one-time passwords correspond to respective ones of the plurality of characters, generating a plurality of modified passwords, wherein generating the plurality of modified passwords comprises concatenating, for each of the plurality of one-time passwords and each of the plurality of characters, the one of the plurality of characters to the corresponding one of the plurality of one-time passwords, generating a plurality of hash values, wherein generating the plurality of hash values comprises performing a hash function on each of the plurality of modified passwords, and sending the plurality of hash values to the data processing system.

In other embodiments of the inventive subject matter, a method comprises sending a request for an authorization code to a mobile device, the authorization code comprising a sequence of a plurality of characters, generating a plurality of one-time passwords, wherein respective ones of the plurality of one-time passwords correspond to respective ones of the plurality of characters, generating, for each of the plurality of one-time passwords, a plurality of modified passwords, wherein generating the plurality of modified passwords comprises concatenating the respective one of the plurality of one-time passwords to each of a plurality of numerical digits of a base ten numeral system, generating a first plurality of hash values, wherein generating the first plurality of hash values comprises performing a hash function on each of the plurality of modified passwords for each of the plurality of one-time passwords, receiving a second plurality of hash values from the mobile device corresponding to the plurality of one-time passwords, respectively, comparing, for each of the second plurality of hash values, the respective one of the second plurality of hash values to respective ones of the first plurality of hash values generated for the respective one of the one-time passwords corresponding to the respective one of the second plurality of hash values, determining, for each of the second plurality of hash values, a match between the respective one of the second plurality of hash values and one of the first plurality of hash values generated for the respective one of the one-time passwords corresponding to the respective one of the second plurality of hash values, and determining the sequence of the plurality of characters of the authorization code based on the ones of the first plurality of hash values generated for the respective ones of the one-time passwords corresponding to the respective ones of the second plurality of hash values that match the respective ones of the second plurality of hash values.

In further embodiments of the inventive subject matter, an electronic device includes a processor and a memory coupled to the processor and comprising computer readable program code embodied in the memory that is executable by the processor to perform operations comprising: receiving, from a data processing system, a request for an authorization code, the authorization code comprising a sequence of a plurality of characters, generating a plurality of counter values, the plurality of counter values corresponding to a plurality of one-time passwords, respectively, wherein respective ones of the plurality of one-time passwords correspond to respective ones of the plurality of characters, performing, for each of the plurality of counter values, a Hash-Based Message Authentication Code (HMAC) protocol, the HMAC protocol having a secret key as a first input and a respective one of the plurality of counter values as a second input, generating a plurality of modified passwords, wherein generating the plurality of modified passwords comprises concatenating, for each of the plurality of one-time passwords and each of the plurality of characters, the one of the plurality of characters to the corresponding one of the plurality of one-time passwords, generating a plurality of hash values, wherein generating the plurality of hash values comprises performing a hash function on each of the plurality of modified passwords, and sending the plurality of hash values to the data processing system

Other methods, systems, devices, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network for facilitating protection of a user authorization code using one-time passwords in accordance with some embodiments of the inventive subject matter;

FIG. 2 illustrates a data processing system that may be used to implement an Interactive Voice Response (IVR) server of FIG. 1 in accordance with some embodiments of the inventive subject matter;

FIG. 3 is a block diagram that illustrates a software/hardware architecture for the IVR server of FIG. 1 in accordance with some embodiments of the present inventive subject matter;

FIG. 4 is a block diagram that illustrates a mobile device/terminal in accordance with some embodiments of the present inventive subject matter;

FIGS. 5 and 6 are flowcharts that illustrate operations for facilitating protection of a user authorization code using one-time passwords in accordance with some embodiments of the inventive subject matter; and

FIG. 7 is a message flow diagram that illustrates operations for facilitating protection of a user authorization code using one-time passwords in accordance with some embodiments of the inventive subject matter.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure embodiments of the present invention. It is intended that all embodiments disclosed herein can be implemented separately or combined in any way and/or combination.

As used herein, the term “data processing system” includes, but it not limited to, a hardware element, firmware component, and/or software component.

As used herein, the term “mobile terminal” or “mobile device” may include a satellite or cellular radiotelephone with or without a multi-line display; a Personal Communications System (PCS) terminal that may combine a cellular radiotelephone with data processing, facsimile and data communications capabilities; a PDA or smart phone that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals or mobile devices may also be referred to as “pervasive computing” devices.

Some embodiments of the inventive subject matter stem from a realization that user transactions that involve the transmission of an authorization code, such as a Personal Identification Number (PIN), may result in the authorization code being unprotected and subject to being compromised due to eavesdropping by one or more hostile parties. An electronic device, such as a mobile terminal, and a data processing system, such as an Interactive Voice Response (IVR) system may each be provisioned with a capability to generate one-time passwords. In some embodiments, the electronic device and the data processing system may each have synchronized counter and may share a secret key. A hash-Based Message Authentication Code (HMAC) protocol may be used to generate the one-time passwords at both the electronic device and the data processing system based on counter values from the synchronized counter and the shared secret key. For each input character of an authorization code, for example, the electronic device may append the input character to a one-time password and perform a hash function on the resultant string. The hash value generated may then be transmitted to the data processing system, which may generate all possible hash values corresponding to combinations of the one-time password with all possible values of one character of an authorization code. For example, if each character of an authorization code corresponds to one numerical digit of a base ten numeral system, then the data processing system may generate ten different hash values corresponding to the ten combinations of the one-time password with digits 0-9. The data processing system may then compare the hash values generated locally with the received hash value to determine the character of the authorization code that was transmitted from the electronic device. Embodiments of the inventive subject matter may, therefore, provide a two phase cryptographic hash protection for transmitting characters of an authorization code based on the use of one-time passwords and hashing the one-time passwords with respective digits of the authorization code. As a result, the authorization code may be better protected from hostile parties attempting to eavesdrop on the communications between the electronic device and the data processing system.

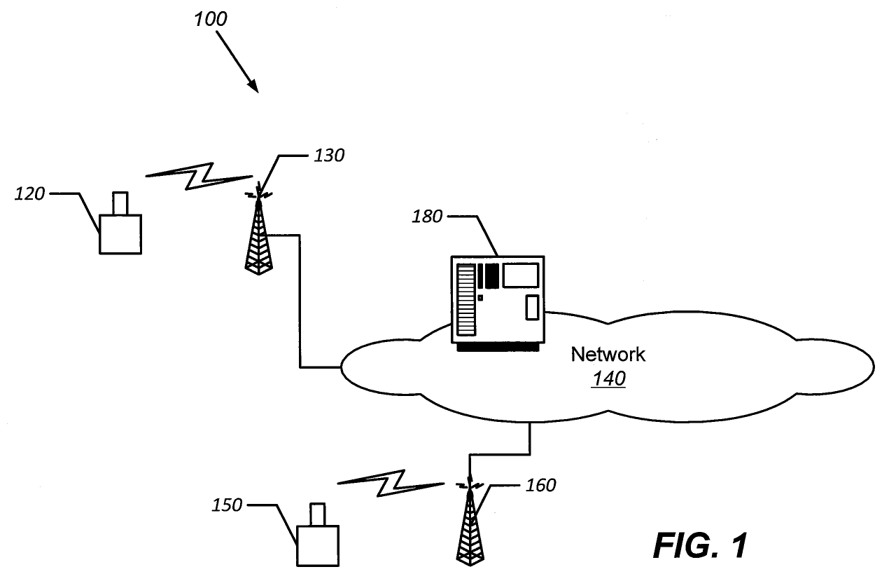

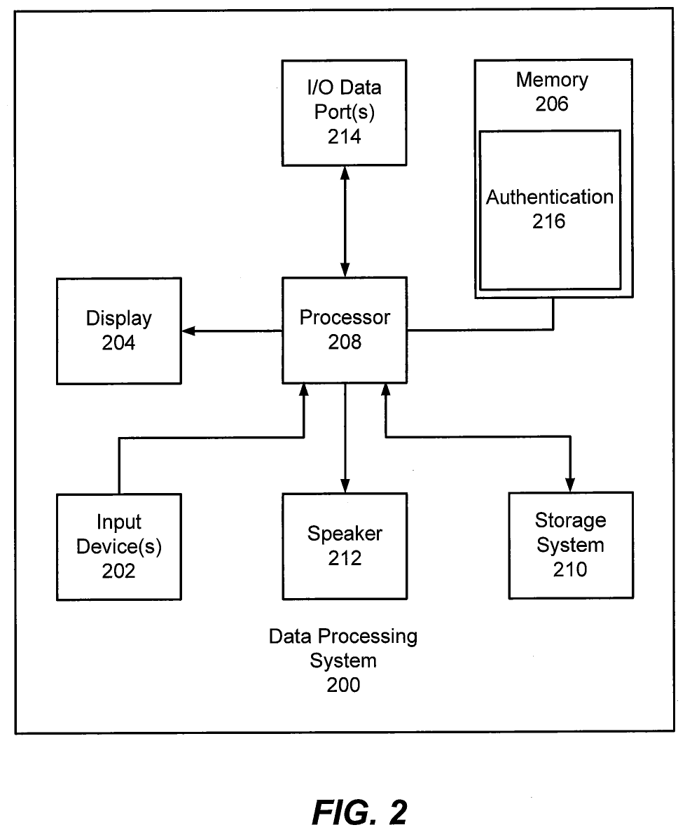

Referring now to FIG. 1, a communication network 100 for facilitating protection of a user authorization code using one-time passwords, according to some embodiments of the inventive subject matter, comprises mobile terminals or devices 120 and 150 that may each have a security application stored thereon, which is executable to facilitate protection of a user authorization code when performing a transaction with another data processing system entity, such as an IVR system. The communication network 100 further comprises a data processing system 180, which, in some embodiments, may be an IVR system. Similar to the mobile terminals or devices 120 and 150, the data processing system 180 may have an authentication application stored thereon, which is executable to securely authenticate users of terminals or devices when performing transactions therewith. The data processing system 180 may communicate with the mobile terminals or devices 120 and 150 by way of the network 140, which comprises wireless base station transceivers 130 and 160. The wireless base station transceivers 130 and 160 may facilitate wireless communication with the mobile terminals 120 and 150, respectively. The network 140 may represent a global network, such as the Internet, or other publicly accessible network. The network 140 may also, however, represent a wide area network, a local area network, an Intranet, or other private network, which may not accessible by the general public. Furthermore, the network 140 may represent a combination of public and private networks or a virtual private network (VPN). Moreover, devices 120 and 130 are described as mobile terminals or devices for purposes of illustrating some embodiments of the present inventive subject matter. It will be understood that terminals or devices 120 and 150 may be any electronic device that is capable of communicating with a data processing system, such as data processing system 180 to perform a transaction that involve involves one or more authorization codes for authenticating a user and/or authorizing the transaction. Although FIG. 2 illustrates an example communication network for facilitating protection of a user authorization code using one-time passwords according to some embodiments of the inventive subject matter, it will be understood that the present invention is not limited to such configurations, but is intended to encompass any configuration capable of carrying out the operations described herein.

Referring now to FIG. 2, a data processing system 200 that may be used to implement the data processing system 180 of FIG. 1, in accordance with some embodiments of the inventive subject matter, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with an authentication module 216 that may be configured to communicate with the mobile terminals or devices 120 and 150 to perform secure transactions therewith in which a user authorization or authentication code is protected through use of one-time passwords according to some embodiments of the inventive subject matter.

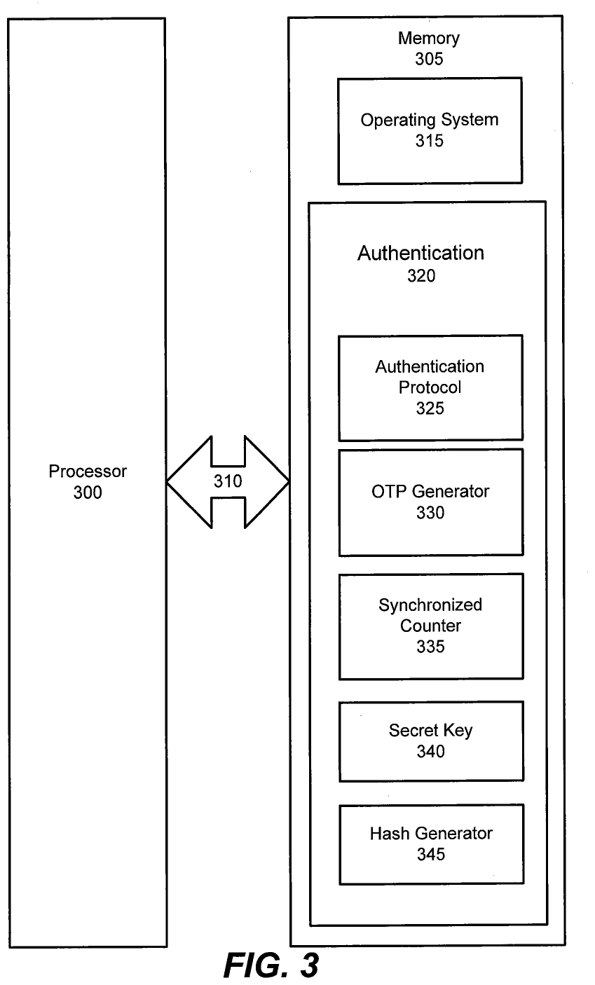

FIG. 3 illustrates a processor 300 and memory 305 that may be used in embodiments of data processing systems, such as the data processing systems 180 and 200 of FIGS. 1 and 2, respectively, for facilitating protection of a user authorization code using one-time passwords in accordance with some embodiments of the inventive subject matter. The processor 300 communicates with the memory 305 via an address/data bus 310. The processor 300 may be, for example, a commercially available or custom microprocessor. The memory 305 is representative of the one or more memory devices containing the software and data used for facilitating protection of a user authorization code using one-time passwords according to some embodiments of the inventive subject matter. The memory 305 may include, but is not limited to, the following types of devices: cache, ROM, PROM, EPROM, EEPROM, flash, SRAM, and DRAM.

As shown in FIG. 3, the memory 305 may contain up to two or more categories of software and/or data: an operating system 315 and an authentication module 320. The operating system 315 generally controls the operation of the data processing system. In particular, the operating system 315 may manage the data processing system's software and/or hardware resources and may coordinate execution of programs by the processor 300. The authentication module 320 includes an authentication protocol module 325, a One-Time Password (OTP) generator module 330, a synchronized counter module 335, a secret key 340, and a hash generator module 345.

The authentication protocol module 325 may be configured to manage communications between a data processing system 180, such as an IVR system, and another entity, such as mobile terminals or devices 120 and 150 to facilitate a secure transaction in which a use authorization code is protected using one-time passwords. In some embodiments, the authentication protocol module 325 may support the use of one or more authentication standards, such as those supported by the Initiative for Open Authentication (OATH). OATH supports two open authentication standards: Time-based One-time Password Algorithm (TOTP) and HMAC-based One-time Password Algorithm (HOTP). When authenticating using TOTP, a user may enter a code that changes every thirty seconds. The code may be generated using HMAC in which a shared secret key and a timestamp are used as inputs. The timestamp may change every thirty seconds. The use of a timestamp in TOTP involves the use of a synchronized clock between the authenticating system and the devices, terminals, etc. being authenticated. HOTP works similarly to TOTP, but an authentication counter is used instead synchronized clock. Similar to the clocks, the counters on both the authenticating system and the devices, terminals, etc. being authenticated do need to remain synchronized.

The OTP generator module 330 may be configured to generate one-time passwords using, for example in some embodiments, the HMAC protocol in which counter values from the synchronized counter 335 and a secret key 340 are used as inputs.

The synchronized counter module 335 may be configured to generate counter values in synchronization with a corresponding counter on another entity, such as a mobile terminal or device 120 and 150.

The secret key 340 may be a value that is generated in concert with another entity, such as a mobile terminal or device 120 and 150. The agreed upon secret key between an authenticating entity, such as a data processing system 180, and an entity being authenticated, such as mobile terminals or devices 120 and 150, may be used as an input value to the HMAC protocol.

The hash generator 345 may be configured to perform a hash function on the passwords output from the OTP generator 330 as respectively modified with possible characters of an authorization or authentication code that may be entered by a user of a mobile terminal or device, such as the mobile terminals or devices 120 and 150 of FIG. 1.

Although FIG. 3 illustrates hardware/software architectures that may be used in data processing systems, such as the data processing system 180 of FIG. 1 and the data processing system 200 of FIG. 2, respectively, for facilitating protection of a user authorization code using one-time passwords, according to some embodiments of the inventive subject matter, it will be understood that the present invention is not limited to such a configuration but is intended to encompass any configuration capable of carrying out operations described herein.

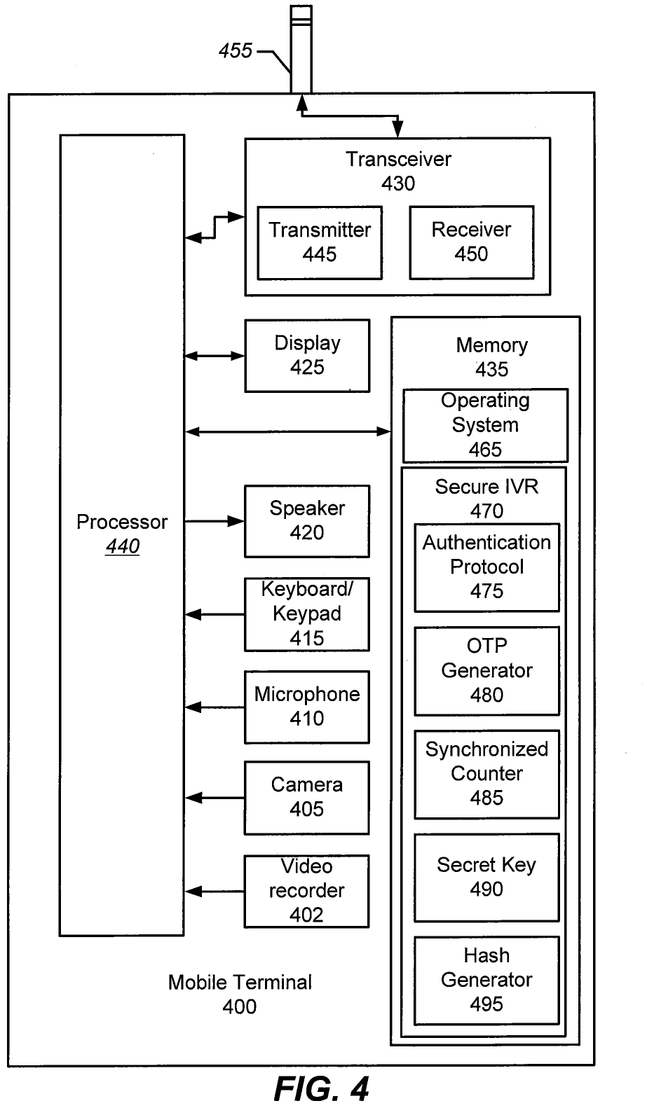

Referring now to FIG. 4, an example mobile terminal 400 that may be used to implement the mobile terminals or devices 120 and 150 of FIG. 1, in accordance with some embodiments of the inventive subject matter, includes a video recorder 402, a camera 405, a microphone 410, a keyboard/keypad 415, a speaker 420, a display 425, a transceiver 430, and a memory 435 that communicate with a processor 440. The transceiver 430 comprises a transmitter circuit 445 and a receiver circuit 450, which respectively transmit outgoing radio frequency signals to base station transceivers and receive incoming radio frequency signals from the base station transceivers via an antenna 455. The radio frequency signals transmitted between the mobile terminal 400 and the base station transceivers may comprise both traffic and control signals (e.g., paging signals/messages for incoming calls), which are used to establish and maintain communication with another party or destination. The radio frequency signals may also comprise packet data information. The foregoing components of the mobile terminal 400 may be included in many conventional mobile terminals and their functionality is generally known to those skilled in the art.

The processor 440 communicates with the memory 435 via an address/data bus. The processor 440 may be, for example, a commercially available or custom microprocessor. The memory 435 is representative of the one or more memory devices containing the software and data used to facilitate protection of a user authorization code using one-time passwords, in accordance with some embodiments of the present invention. The memory 435 may include, but is not limited to, the following types of devices: cache, ROM, PROM, EPROM, EEPROM, flash, SRAM, and DRAM.

As shown in FIG. 4, the memory 435 may contain up to two or more categories of software and/or data: the operating system 465 and a secure IVR module 470. The operating system 465 generally controls the operation of the mobile terminal 400. In particular, the operating system 465 may manage the mobile terminal's software and/or hardware resources and may coordinate execution of programs by the processor 440.

The secure IVR module 470 may be configured to manage communications between the mobile terminal 400 and a data processing system 180, such as an IVR system to facilitate a secure transaction in which a use authorization code is protected using one-time passwords. The secure IVR module 470 may include an authentication protocol module 475, an OTP generator module 480, a synchronized counter module 485, a secret key 490, and a hash generator module 495. The authentication protocol module 475, OTP generator module 480, synchronized counter module 485, secret key 490, and hash generator module 495 may be analogs of the authentication protocol module 325, the OTP generator module 330, the synchronized counter module 335, the secret key 340, and the hash generator module 345.

The authentication protocol module 475 may support the use of one or more authentication standards, such as TOTP and HOTP supported by OATH.

The OTP generator module 480 may be configured to generate one-time passwords using, for example in some embodiments, the HMAC protocol in which counter values from the synchronized counter 485 and a secret key 490 are used as inputs.

The synchronized counter module 485 may be configured to generate counter values in synchronization with a corresponding counter on another entity, such as the synchronized counter 335 on a data processing system 180, such as an IVR system.

The secret key 490 may be a value that is generated in concert with another entity, such as a data processing system 180, which may be an IVR system. The agreed upon secret key between an authenticating entity, such as a data processing system 180, and an entity being authenticated, such as mobile terminals or devices 120 and 150, may be used as an input value to the HMAC protocol. Thus, the secret key 490 and the secret key 340 represent the agreed upon key value between a data processing system 180, such as an IVR system (authenticating or authorizing entity), and a mobile terminal or device 120, 150 (entity being authenticated or authorized).

The hash generator 345 may be configured to perform a hash function on the passwords output from the OTP generator 330 as respectively modified with characters of an authorization or authentication code entered by a user of a mobile terminal or device, such as the mobile terminals or devices 120 and 150 of FIG. 1.

Although FIG. 4 illustrates an example software and hardware architecture that may be used to provide a mobile terminal that can facilitate protection of a user authorization code using one-time passwords according to some embodiments of the inventive subject matter, it will be understood that embodiments of the present invention are not limited to such a configuration, but are intended to encompass any configuration capable of carrying out the operations described herein.

Computer program code for carrying out operations of data processing systems, mobile terminals, and/or electronic devices discussed above with respect to FIGS. 1-4 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the mobile terminals or devices 120 and 150 of FIG. 1, the data processing system 180 of FIG. 1, the data processing system 200 of FIG. 2, the hardware/software architecture of FIG. 3, and the mobile terminal of FIG. 4 may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

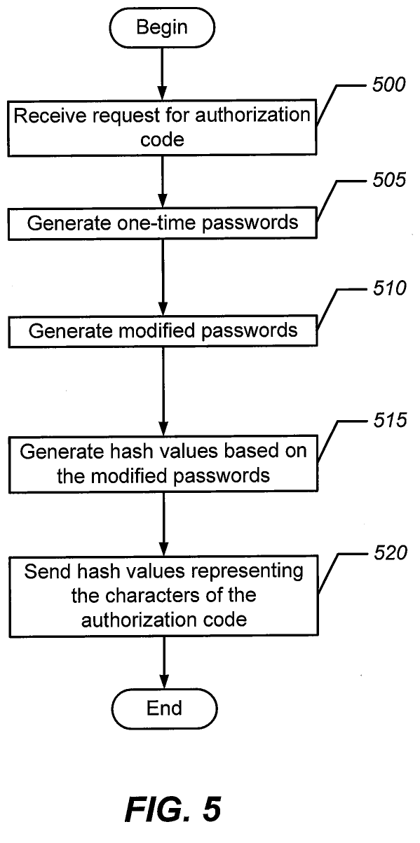

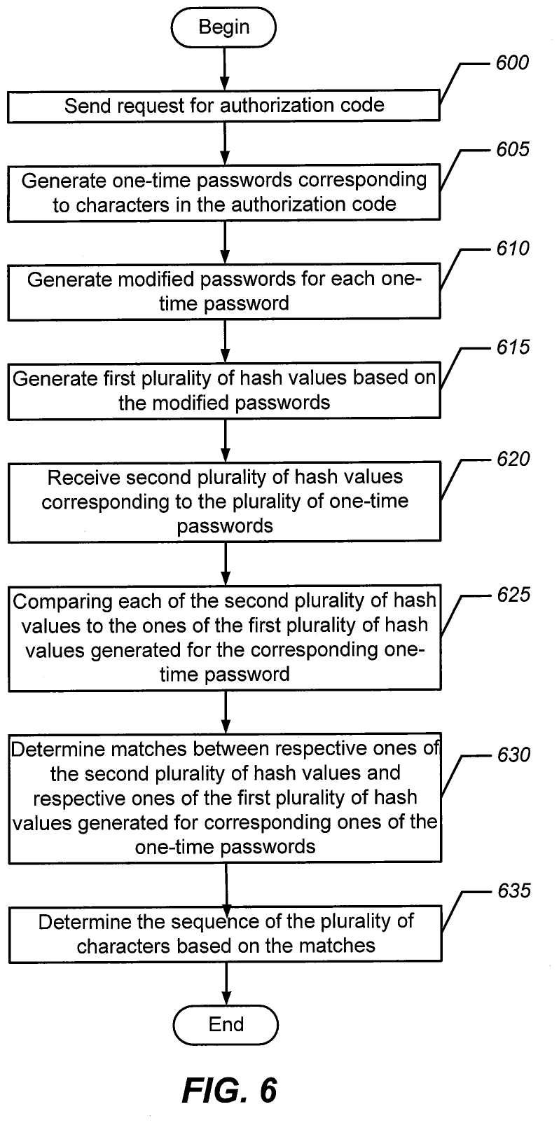

FIGS. 5 and 6 are flowcharts that illustrate operations for facilitating protection of a user authorization code using one-time passwords in accordance with some embodiments of the inventive subject matter. Referring now to FIG. 5, operations of a mobile terminal or device, such as a mobile terminal or device 120, 150, 400, begin at block 500 where a request for an authentication or authorization code is received from, for example, a data processing system, such as data processing system 180. In some embodiments, the mobile terminal or device 120, 150, 400 may be used to perform a transaction, such as a payment transaction. The mobile terminal or device 120, 150, 400 may communicate with a data processing system, such as an IVR system, and may be used to provide payment card information over the communication channel The IVR system may request that some type of authorization code or user authentication code, such as a PIN code, be provided by the user before the transaction will be allowed to proceed. Thus, at block 505, the mobile terminal or device 120, 150, 400 may generate a plurality of one-time passwords using, for example, the HMAC protocol where a plurality of counter values and a secret key are used as input values for the HMAC protocol. With each received PIN character from the user, a modified password is created by appending the received character to a one-time password at block 510. The PIN characters may include, but are not limited to, numerical digits of the base ten numeral system. At block 515, a hash function may be applied to the modified passwords that are created by appending each of the characters in the authentication or authorization code, e.g., PIN code, to a respective one of the one-time passwords to generate hash values respectively corresponding to each of the characters comprising the authorization or authentication code. These hash values are sent at block 520 to the data processing system 180, e.g., the IVR system, using, for example, Dual Tone Multi-Frequency (DTMF) signaling.

The operations of blocks 505, 510, 515, and 520 may be performed in various orders in accordance with different embodiments of the inventive concept. For example, upon receiving a first character or digit of a PIN code, the mobile terminal or device 120, 15, 400 may generate a one-time password (block 505), modify the one-time password by appending the first digit of the PIN code thereto (block 510), generate a hash value based on the modified one-time password (block 515), and then send the hash value to the data processing system, e.g., the IVR system (block 520). These operations may then be repeated for the next digit in the PIN code sequence. In other embodiments, multiple one-time passwords may be generated in advance and all digits or characters of an authorization or authentication code may be received before the modified passwords and hash values are generated.

Referring now to FIG. 6, operations of a data processing system 180, such as an IVR, according to some embodiments of the inventive subject matter, begin at block 600 where the data processing system 180 sends a request for an authorization or authentication code, such as a PIN code, to a mobile terminal or device 120, 150. At block 605, one-time passwords are generated using, for example, the HMAC protocol where a plurality of counter values and a secret key are used as input values for the HMAC protocol. The counter values may be generated by a counter that is synchronized with a corresponding counter on the mobile terminal or device 120, 150, such as synchronized counters 335 and 485. The secret key may be a value agreed upon between the data processing system 180 and the mobile terminal or device 120, 150. The number of one-time passwords generated may correspond to the number of characters in the authorization or authentication code, such as a PIN code. A modified password is generated for the one-time passwords by appending each of the eligible characters used in the authorization or authentication code to a respective one of the one-time passwords at block 610. Thus, if the authorization code or authentication code is a sequence of four numerical digits of the base ten numeral system, then ten modified passwords are generated with each of the digits 0-9 appended to four different one-time passwords for a total of forty different modified one-time passwords. A hash function is applied to reach of the modified one-time passwords to generate a plurality of hash values at block 615. At block 620, the hash values corresponding to the authorization or authentication code, e.g., a PIN code, are received from a mobile terminal or device 120, 150. Each of the received hash values is compared to the plurality of all possible hash values generated at block 615 for all possible characters in the authorization or authentication code at block 625 to determine which hash values match at block 630. As the data processing system 180, e.g., the IVR system, can match hash values of modified one-time passwords to the authorization or authentication code characters used to generate the hash values, the characters of the authorization or authentication code sent from the mobile terminal or device 120, 150 may be determined at block 635.

The operations of blocks 605, 610, 615, 620, 625, 630, and 635 may be performed in various orders in accordance with different embodiments of the inventive concept. For example, at block 605, a one-time password may be generated for a first character or digit of a PIN code using the HMAC protocol with a synchronized counter value and a secret key value as inputs. At block 610, modified one-time passwords may be generated corresponding to the one-time password appended with each of the possible values of the first digit of the PIN code. For example, if the PIN code may take on values of numerical digits of the base ten numeral system, then ten modified one-time passwords may be generated corresponding to the one-time password appended with each of the digits 0-9. Hash values may be generated using the same hash function used to generate the hash values on the mobile terminal or device 120, 150 for the modified one-time passwords at block 615. When the hash value corresponding to the first digit of the authorization or authentication code is received at block 620 from the mobile terminal or device 120, 150, then a comparison is made at block 625 between the received hash value and the ten hash values generated for the modified one-time password for the first digit of the authorization code to determine at match at block 630. Based on the matching hash value, the first character or digit can be determined for the PIN code at block 635. The operations of blocks 605, 610, 615, 620, 625, 630, and 635 can be repeated for each of the sequence of characters or digits of the authorization or authentication code.

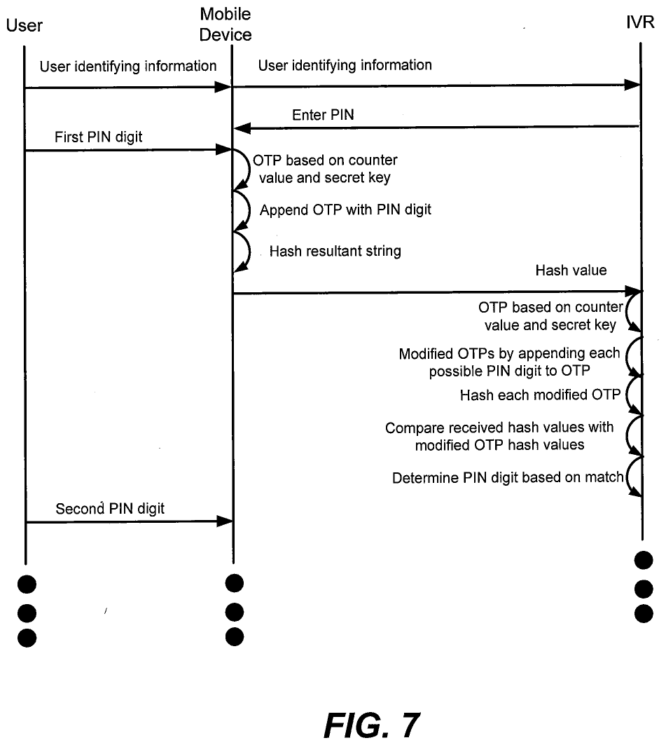

FIG. 7 is a message flow diagram that illustrates operations for facilitating protection of a user authorization code using one-time passwords in accordance with some embodiments of the inventive subject matter. In the message flow diagram of FIG. 7, the mobile device e.g., mobile terminal or device 120, 150, and the IVR, e.g., data processing system 180 may generate a secret key value in concert for use by each of the mobile terminal or device and the IVR. Likewise, the mobile device and IVR may use synchronized counter generators 485 and 385, respectively, which generate counter values in synchronization with each other for use as an input the HMAC protocol, for example, to generate the same one-time passwords on each respective device/system. As shown in FIG. 7, the user may enter identifying information, such as payment card information, which is communicated to the IVR. The IVR may request an authorization or authentication code be entered, such as a PIN code before a transaction will be allowed to proceed or complete. The user may then enter a first PIN digit, which results in the mobile device generating a one-time password using the HMAC protocol with a synchronized counter value and the secret key value as inputs. The one-time password is appended with the PIN digit and a hash function is applied to the resultant string. The hash value may then be transmitted to the IVR where the IVR generates the one-time password based on a synchronized counter value and the agreed upon secret key. The IVR generates multiple modified one-time passwords corresponding to the one-time password with all possible values for a PIN digit appended thereto. The same hash function used by the mobile device is used to generate a hash value for each of the modified one-time passwords to generate a plurality of hash values corresponding to all possible PIN digits that could have been entered by the user. A comparison is made between the hash value received from the mobile device with the plurality of all possible hash values to determine which one of the plurality of hash values matches. The matching hash value corresponds to the PIN digit entered by the user. Thus, the first PIN digit can be determined as the IVR knows the association between the PIN digit values and the hash values generated based on the modified one-time passwords. Thus, the first PIN digit can be determined. These operations continue for the second digit and each subsequent digit of the PIN code until all of the digits are determined.

Embodiments of the inventive subject matter may, therefore, provide a mechanism for communicating personal user information, such as PIN codes and the like, in a protected manner through use of one-time passwords and hash functions that may be difficult for hostile parties to decode if the information is intercepted on a communication path between a user device, such as a mobile terminal or device, and a data processing system, such as a transaction processing system and/or IVR.

### Further Definitions and Embodiments:

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Peri, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What which is claimed:

1. A method, comprising:
receiving, from a data processing system, a request for an authorization code, the authorization code comprising a sequence of a plurality of characters;
generating a plurality of one-time passwords, wherein respective ones of the plurality of one-time passwords correspond to respective ones of the plurality of characters;
generating a plurality of modified passwords, wherein generating the plurality of modified passwords comprises concatenating, for each of the plurality of one-time passwords and each of the plurality of characters, the one of the plurality of characters to the corresponding one of the plurality of one-time passwords;
generating a plurality of hash values, wherein generating the plurality of hash values comprises performing a hash function on each of the plurality of modified passwords; and
sending the plurality of hash values to the data processing system.

2. The method of claim 1, wherein generating the plurality of one-time passwords comprises:
generating a plurality of counter values, the plurality of counter values corresponding to the plurality of one-time passwords, respectively; and
performing, for each of the plurality of counter values, a Hash-Based Message Authentication Code (HMAC) protocol, the HMAC protocol having a secret key as a first input and a respective one of the plurality of counter values as a second input.

3. The method of claim 2, wherein generating the plurality of counter values comprises:
operating a first counter; and
synchronizing the first counter with a second counter associated with the data processing system.

4. The method of claim 2, further comprising:
generating the secret key in concert with the data processing system.

5. The method of claim 1, wherein the plurality of characters comprises a plurality of numerical digits of a base ten numeral system.

6. The method of claim 1, further comprising:
sending information to the data processing system;
wherein the authorization code is associated with the information.

7. The method of claim 6, wherein the data processing system comprises an Interactive Voice Response (IVR) system;
wherein the authorization code is a Personal Identification Number (PIN); and
wherein the information comprises payment card information.

8. The method of claim 1, wherein sending the plurality of hash values comprises:
sending the plurality of hash values to the data processing system using Dual Tone Multi-Frequency (DTMF) signals over a wireless network.

9. A method, comprising:
sending a request for an authorization code to a mobile device, the authorization code comprising a sequence of a plurality of characters;
generating a plurality of one-time passwords, wherein respective ones of the plurality of one-time passwords correspond to respective ones of the plurality of characters;
generating, for each of the plurality of one-time passwords, a plurality of modified passwords, wherein generating the plurality of modified passwords comprises concatenating the respective one of the plurality of one-time passwords to each of a plurality of numerical digits of a base ten numeral system;
generating a first plurality of hash values, wherein generating the first plurality of hash values comprises performing a hash function on each of the plurality of modified passwords for each of the plurality of one-time passwords;
receiving a second plurality of hash values from the mobile device corresponding to the plurality of one-time passwords, respectively;
comparing, for each of the second plurality of hash values, the respective one of the second plurality of hash values to respective ones of the first plurality of hash values generated for the respective one of the one-time passwords corresponding to the respective one of the second plurality of hash values;
determining, for each of the second plurality of hash values, a match between the respective one of the second plurality of hash values and one of the first plurality of hash values generated for the respective one of the one-time passwords corresponding to the respective one of the second plurality of hash values; and
determining the sequence of the plurality of characters of the authorization code based on the ones of the first plurality of hash values generated for the respective ones of the one-time passwords corresponding to the respective ones of the second plurality of hash values that match the respective ones of the second plurality of hash values.

10. The method of claim 9, wherein generating the plurality of one-time passwords comprises:
generating a plurality of counter values, the plurality of counter values corresponding to the plurality of one-time passwords, respectively; and
performing, for each of the plurality of counter values, a Hash-Based Message Authentication Code (HMAC) protocol, the HMAC protocol having a secret key as a first input and a respective one of the plurality of counter values as a second input.

11. The method of claim 10, wherein generating the plurality of counter values comprises:
operating a first counter; and
synchronizing the first counter with a second counter associated with the mobile device.

12. The method of claim 10, further comprising:
generating the secret key in concert with the mobile device.

13. The method of claim 9, wherein the plurality of characters comprises a plurality of numerical digits of the base ten numeral system.

14. The method of claim 9, further comprising:
receiving information from the mobile device;
wherein the authorization code is associated with the information.

15. The method of claim 14, wherein the authorization code is a Personal Identification Number (PIN); and
wherein the information comprises payment card information.

16. The method of claim 9, wherein receiving the second plurality of hash values comprises:
receiving the second plurality of hash values from the mobile device via Dual Tone Multi-Frequency (DTMF) signals over a wireless network.

17. An electronic device, comprising:
a processor; and
a memory coupled to the processor and comprising computer readable program code embodied in the memory that is executable by the processor to perform operations comprising:
receiving, from a data processing system, a request for an authorization code, the authorization code comprising a sequence of a plurality of characters;
generating a plurality of counter values, the plurality of counter values corresponding to a plurality of one-time passwords, respectively, wherein respective ones of the plurality of one-time passwords correspond to respective ones of the plurality of characters;
performing, for each of the plurality of counter values, a Hash-Based Message Authentication Code (HMAC) protocol, the HMAC protocol having a secret key as a first input and a respective one of the plurality of counter values as a second input;
generating a plurality of modified passwords, wherein generating the plurality of modified passwords comprises concatenating, for each of the plurality of one-time passwords and each of the plurality of characters, the one of the plurality of characters to the corresponding one of the plurality of one-time passwords;
generating a plurality of hash values, wherein generating the plurality of hash values comprises performing a hash function on each of the plurality of modified passwords; and
sending the plurality of hash values to the data processing system.

18. The electronic device of claim 17, wherein the data processing system comprises an Interactive Voice Response (IVR) system, the operations further comprising:
sending information to the IVR system;
wherein the authorization code is a Personal Identification Number (PIN) associated with the information; and.
wherein the information comprises payment card information.

19. The electronic device of claim 17, wherein sending the plurality of hash values comprises:
sending the plurality of hash values to the data processing system using Dual Tone Multi-Frequency (DTMF) signals over a wireless network.

20. The method of claim 17, wherein the plurality of characters comprises a plurality of numerical digits of the base ten numeral system.
